(19) United States
(12) Patent Application Publication
(10) Pub. No.: US 2003/0043268 A1
(43) Pub. Date: Mar. 6, 2003

(54) EyeTap vehicle or vehicle controlled by headworn camera, or the like

(76) Inventor: W. Stephen G. Mann, Toronto (CA)

Correspondence Address: W. Stephen G. Mann, Suite 701, 284 Bloor Street West, Toronto, ON, M5S 3B8, CA

(21) Appl. No.: 09/944,430

(22) Filed: Sep. 4, 2001

(51) Int. Cl. H04N 7/18

(52) U.S. Cl. 348/143; 345/8

(57) ABSTRACT

A vehicle is controlled by a sensor such as an EyeTap device or a headworn camera., so that the vehicle drives in whatever direction the driver looks. The vehicle may be a small radio controlled car or airplane or helicopter driven of flown by a person outside the car or plane, or the vehicle may be a car, plane, or helicopter, or the like, driven or flown by a person sitting inside it. A differential direction system allows a person's head position to be compared to the position of the vehicle, to bring the difference in orientations to a zero, and a near zero difference may be endowed with a deliberate drift toward a zero difference. Preferably at least one of the sensors (preferably a headworn sensor) is a video camera. Preferably the sensor difference drifts toward zero when the person is going along a straight path, so that the head position for going straight ahead will not drift away from being straight ahead. The invention can be used with a wide range of toy cars, model aircraft, or fullsize vehicles, airplanes, fighter jets, or the like.

### FIELD OF THE INVENTION

The present invention pertains generally to a toy car, model aircraft, or to a real vehicle, airplane, fighter jet, or the like.

### BACKGROUND OF THE INVENTION

Toy cars are ordinarily equipped with a joystick radio remote control. Cheap cars often have a binary control, or poor resolution control, whereas better cars will often feature a proportional control. A toy car such as a Radio Shack TIGER 88 provides a satisfactory driving experience by way of a proportional radio control. Even higher quality model cars are often equipped with a separate radio such as a Challenger 250 radio. Some companies, such as Futaba, specialize in the manufacture of radio remote controls for toy cars, model airplanes, helicopters, and the like. Video cameras with video transmitters may be affixed to such vehicles so that they can be remotely operated while watching a television receiving the signal from the video camera. Instead of watching a hand-held television receiver, an operator of such a vehicle could wear a head mounted display to operate the vehicle.

Some sit-in vehicles, such as wheelchairs, usually have a joystick control, but some have a control that can be operated with the head of the driver, by banging into switches mounted for being hit by the head. Fullsize airplanes also have various kinds of controls. Automobiles have varous kinds of controls, especially in situations where a disabled person operates the vehicle. In such situations new methods of driving a vehicle may be desirable.

### SUMMARY OF THE INVENTION

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 is a diagram showing a toy car such as a TIGER 88 being remotely operated by a person wearing EyeTap eyeglasses to steer the car.

FIG. 2 shows a differential guidance system.

FIG. 3 shows a wearable system in which both sensors of a differential guidance system are attached to the body of a person who can sit in a vehicle and drive the vehicle while sitting in it.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

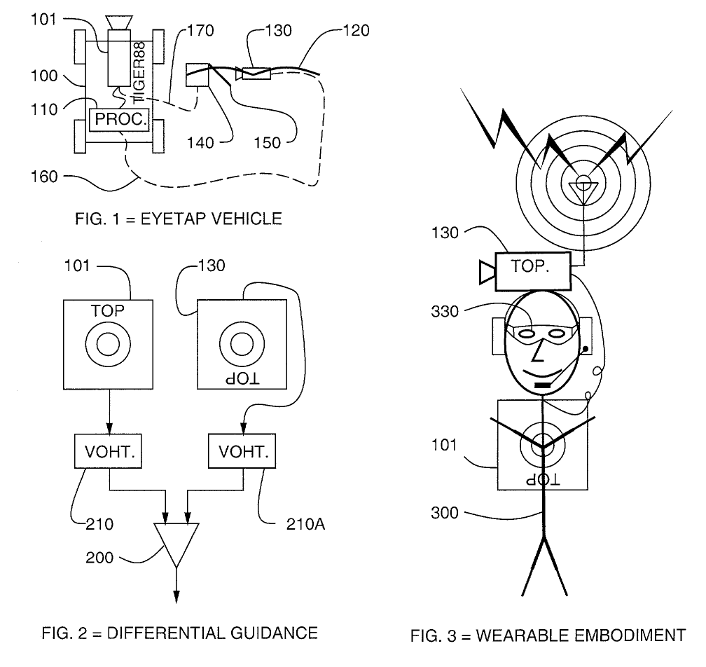

FIG. 1 depicts a vehicle 100. A satisfactory vehicle 100 is a TIGER 88 radio remote controlled car sold by Radio Shack. A sensor 101 is attached to the vehicle 100. The sensor 101 may be a measurement device such as a shaft encoder on the wheels of the vehicle 100, or the sensor 101 may be nothing more than a knowledge of what signals are sent to motors or actuators in vehicle 100. For example, by coulomb counting the electric drive to the motors that make the car steer we can estimate how much steering happened, without even the need to have a shaft encoder. The accuracy may not be as good, but if we apply Humanistic Intelligence (having the human being in the feedback loop of the computational process) we can work with even just a poor estimate of the amount of turning, position, or the like, of the vehicle 100.

Alternatively, sensor 101 is responsive to environmental conditions around the vehicle, such as the earth's magnetic field, or of inertial state, as may be provided by an intertial guidance system, or the like. In a preferred embodiment, the sensor 101 is a video camera with a field of view and orientation approximately equivalent to what a driver of the car would have experienced if the car were large enough to have a real person driving it. An output of sensor 101 is connected to an input of a processor 110. If sensor 101 is a video camera, the processor 110 may then have a video capture interface for sensor 101. The processor 110 provides an interface to all or part of the computational control system for driving vehicle 100. Preferably, the processor 110 is also responsive to an output of a second sensor 130. Preferably the second sensor 130 is an EyeTap camera, in the sense that it is a device that causes an eye of a driver of vehicle 100 to function as if the eye itself were, in effect a camera. This EyeTap effect, as described in the eyetap.org web site, is achieved by having sensor 130 mounted in eyeglass frames 120 wherein a diverter 150 diverts rays of light that would otherwise pass through the center of projection of an eye of a wearer of eyeglass frames 120 into a center of projection of camera sensor 130.

Vehicle 100 is remotely driven by a wearer of eyeglass frames 120, in which a wireless communications link 160 from sensor 130 to processor 110, in combination with sensor 101 provides for all or part of a control system for driving vehicle 100. The driver and the vehicle may be in the same room, or the vehicle may be driven down a hallway and around a corner, or otherwise out of direct sight of the driver, such that the driver operates the vehicle by using sensor 101 or additional sensors to obtain situational vehicle awareness. In embodiments in which sensor 101 is a video camera, a wireless communications link 170 provides the driver with a view looking out from the car, so that the driver can see where the car is going. This view may be superimposed onto the driver's real world view by way of an aremac or video display 140.

A key inventive step is the differencing of sensors 101 and 130, especially for steering the vehicle. For example, when the driver wishes to turn the car left, the driver looks left by turning his or her head to the left. Sensor 130 is responsive to the environment as when sensor 130 is an electronic compass, intertial guidance system, or the like, or when sensor 130 is a video camera. In either case, sensor 130 has a reversed effect from sensor 101. Thus when the driver wishes to turn the car left, the driver looks left, by turning his head to the left, causing sensor 130 to produce a signal received by processor 110. Preferably the control is a proportional control so that the more the driver looks to the left, the faster the leftward turning of the car. Also, it is preferable that the system provides an inverse proportional control, such that as the car begins to turn left, sensor 101 causes the car to turn leftward more slowly. Once the car has turned far enough left, as determined by sensor 101, in relationship to sensor 130, the car stops turning left, and continues on a straight course.

Preferably the proportionality gains are adjusted such that the car goes wherever the driver looks. Thus if the driver sees that there is a doorway to the right, the driver looks to the right to cause the car to turn right so that it can go through the doorway. When the car actually turns right, far enough, the doorway will now show in the center of the frame of video as seen by video sensor 101, and will therefore stop turning.

Preferably the gains are calibrated, such as by programming processor 110, so that whenever the car catches up with where the driver is looking, it stops turning.

Camera sensor 101 may be such that it provides a different field of view than the field of sensing of sensor 130, in which case the gain is preferably adjusted such that there is compensation for this difference. Camera sensor 101 may have a zoom lens, in which case the control system sensitivity is automatically adjusted so that the sensors are calibrated, so that the car still goes where the driver looks, e.g. to the center of the frame of the driver's viewfinder.

Alternatively, a noncamera sensor 101 is used in conjunction with another camera on vehicle 100 so that the driver can still see through the other camera on the vehicle.

FIG. 2 shows a simple way of achieving such a processor with a wye connector 200 for two head trackers 210 and 210A. Head trackers 210 and 210A may be VideoOrbits Head Trackers (VOHTs) that each receive an input from video camera sensors 101 and 130.

VideoOrbits Head Trackers are commonly used to control the position of a cursor on a computer screen. For example, head trackers 210 and 210A can output signals that would normally be read by a PS/2 mouse input on a standard computer. In this case, the wye connector 200 can simply be a PS/2 wye connector as is commonly available commercially. In this way, by mounting one of the sensors upside down with respect to the other, a subtraction operation is performed for free, to give rise to a differential guidance system.

Note that only one of these two devices is actually worn on the head, so the other one that is not worn on the head should (or could) really better be referred to as a vehicle tracking device.

Various other kinds of head tracking devices may be used, one being worn on the head, and the other being placed in or in the vehicle.

The head tracker comprised of sensor 130 can be used to steer left and right by looking left and right, but also a throttle speed and direction can be controlled by looking up and down. Thus velocity control is provided by looking up and down. To speed up, the driver looks up, and to speed down, the driver looks down. Velocity provides direction, preferably in a proportional manner, so that if the user looks down the car will slow down and eventually stop and speed up in the reverse direction. To slow down quickly, the driver can look all the way down, to put the engine(s) into full reverse. Then the driver can look straight ahead when the car reaches a standstill, in order to stop it from reversing due to the engine(s) being in reverse.

The invention can also be used to fly reconaissance airplanes that are outfitted with sensors such as television cameras with wireless communication. The full three degrees of freedom (yaw, pitch, and roll) of the pilot's head can then be used to fly the airplane, and allow the pilot to turn left and right, as well as turn up and down, as well as adjust the throttle.

Additionally, even when driving a car (where only 2 degrees of freedom are needed), the third degree of freedom can be used as a meta control. For example, a driver may wish to turn his or her head without affecting the car. Thus there can be an on/off control that is accessed by rotating the head about the effective optical center of camera sensor 130. Rotating the head is the meta control, whereas looking up and down or left and right are the actual controls (throttle and steering). Other forms of meta control may include rotating the head while looking left or right. Rotating the head while looking up and down can also be meta commands.

Flying a radio controlled helicopter, being more complicated, can also make good use of these meta commands, along with intelligent visual feedback, to achieve a good implementation of Humanistic Intelligence (H.I.).

FIG. 3 depicts a situation in which the driver of the vehicle would like to be inside the vehicle rather than outside of it. In this case, the situation as to which camera is upside down is reversed, since the driver would like to see normally through a wearable camera sensor 130 that is upright, whereas the reference camera sensor 101 is upside down. Instead of a headworn camera sensor 130, an EyeTap 330 may be used. The figure depicts the right eye of the wearer 300 being tapped. A wireless communications link allows the wearer 300 access to control apparatus to communicate with the vehicle and control the vehicle.

Two sensors, one sensor 130 attached to the wearer's head, and a second sensor 101 attached to the wearer's body, provide the differenced proportional control of the invention in which the wearer 300 can steer the vehicle by turning his or her head left or right. Sensor 101 on the wearer's torso indicates to the control system when the vehicle has caught up with where the wearer 300 was looking. Alternatively, the reference sensor 101 can still be mounted in the vehicle. However, by mounting it on the wearer 300 (i.e. the driver), the bulk of the infrastructure is worn by the driver, so that the vehicle only needs to be outfitted with a way of being steered. Moreover, in some embodiments, processor 110 is attached to the body of the driver, so as to further minimize the amount of specialization needed of the vehicle. In this way, a driver with special needs (e.g. a person who only has control of his or her head) can operate a vehicle by simply outfitting the vehicle with nothing more than a steering interface. In vehicles with electronic control of steering (e.g. electric wheelchairs, electrically steered cars, electronically controlled airplanes, etc.), all that is required is a place to plug in the steering interface. If the vehicle is already equipped with a potentiometer to steer, then all that is needed is for the wearer's computer to have an interface that actuates or simulates the potentiometer.

Additinally, the invention can be used with computer driving or flight simulations, such as might be found in video games. In this case, sensor 130 is on the wearer's head, and sensor 101 may be a virtual sensor simply inherent as part of the simulation. In such a virtual driving system, a preferred embodiment is one in which the wearer 300 uses a virtual reality headset to view a virtual driving game.

Preferably there is a deliberately induced drift toward zero of the difference in a differential tracking system of FIG. 1, FIG. 2, or FIG. 3, such that small differences between the orientations reported by both trackers (especially when such small differences result in tracker drift) are themselves decayed toward zero.

This deliberately induced zero differential drift is preferably accelerated during straight-path driving, especially when the vehicle is not accelerating. Thus the system zeros itself and calibrates itself, or at least rezeros itself and recalibrates itself.

Various other combinations are possible within the scope of the invention and appended claims. Various locations for sensors, nobath signal generators, nobath detectors, and other personal safety devices may be considered.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

From the foregoing description, it will thus be evident that the present invention provides a design for a lookdriving vehicle. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications., if within the spirit of this invention, are intended to be encompassed within the scope of any claims to patent protection issuing upon this invention.

The embodiments of the invention in which I claim an exclusive property or privilege are defined as follows:

1. A drive-where-looking vehicle comprising:
a body sensor for being borne by a body of a driver of said vehicle;
a vehicle sensor for being borne by said vehicle;
a processor,
said processor responsive to an input from said body sensor and said vehicle sensor, said processor providing an output to at least one steering control of said vehicle.

2. The drive-where-looking vehicle of claim 1, including a video camera borne by said vehicle, and a video display for being borne by said driver.

3. The drive-where-looking vehicle of claim 2, said video display being a headworn display, said body sensor borne by said headworn display.

4. The drive-where-looking vehicle of claim 3, where said body sensor is a headworn camera borne by said headworn display.

5. The drive-where-looking vehicle of claim 1, where exactly one of:
said body sensor; and
said vehicle sensor,
is mounted upside down with respect to the other sensor.

6. The drive-where-looking vehicle of claim 1, where one of:
said body sensor; and
said vehicle sensor,
is a first camera, and the other sensor is a second camera, said first camera being mounted upside down with respect to said second camera.

7. The drive-where-looking vehicle of claim 1, further including a deliberate differential drift to zero feature.

8. The drive-where-looking vehicle of claim 1, further including a deliberate differential drift to zero tendency said tendency proportional to a straightness of trajectory of said vehicle.

9. The drive-where-looking vehicle of claim 1,
